(19) United States
(12) Patent Application Publication
(10) Pub. No.: US 2010/0169362 A1
(43) Pub. Date: Jul. 1, 2010

(54) PALETTE FOR ACCESSING DOCUMENT HISTORY

(75) Inventors: James C. Bulfani, JR., Honolulu, HI (US); Eric Chatonet, Paris (FR); Claudie Marie-Ange Camus, Paris (FR)

Correspondence Address: CONLEY ROSE, P.C.;David A. Rose, P. O. BOX 3267, HOUSTON, TX, 77253-3267, US

(73) Assignee: VISISOFT, LLC, Houston, TX (US)

(21) Appl. No.: 12/492,878

(22) Filed: Jun. 26, 2009

Related U.S. Application Data
(60) Provisional application No. 61/076,267, filed on Jun. 27, 2008.

(51) Int. Cl. G06F 3/048; G06F 3/01; G06F 17/30

(52) U.S. Cl. 707/769; 715/771; 715/760; 715/786; 707/E17.014

(57) ABSTRACT

A palette for accessing document history. At least some of the illustrative embodiments are methods comprising rendering on a display a palette within a window of a software, the rendering by executing a software application by a processor, obtaining information pertaining to the software without prompting a user to enter the information pertaining to software, the obtaining responsive to selecting a first icon, and storing the information pertaining to the software.

### BACKGROUND

Web-browsers are software applications that enable users to access content on the World Wide Web (“Web”) by way of the Internet. Users often encounter various practical difficulties while browsing the Web (e.g., organizing favorite Webpages; recalling which Webpages were relevant to the user's search and which were not; recalling which pages the user visited at all). Web-browsers provide access to Internet content but fail to adequately address many practical difficulties.

### BRIEF DESCRIPTION OF THE DRAWINGS

For a more detailed description of the various embodiments, reference will now be made to the accompanying drawings, wherein:

FIG. 1 shows an illustrative computer system in accordance with at least some of the embodiments;

FIG. 2 shows an illustrative Web-browser in accordance with at least some of the embodiments;

FIG. 3 shows an illustrative palette rendered with a Web-browser in accordance with at least some of the embodiments;

FIG. 4 shows a palette in another location relative to a Web-browser in accordance with at least some of the embodiments;

FIG. 5 shows a drop-down menu associated with a palette in accordance with at least some of the embodiments;

FIG. 6A-6D shows a control console in accordance with at least some of the embodiments;

FIG. 7A-7D shows an illustrative scrollbar rendered with the control console in accordance with at least some of the embodiments; and

FIG. 8 shows a method in accordance with at least some of the embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct electrical or wireless connection, or through an indirect electrical or wireless connection via other devices and connections.

“Palette” shall mean a window that does not have customary window controls (Le., minimize, maximize and close buttons), may be of irregular (non-rectangular) shape, and can be transparent, thus exposing only the control functionality.

“Image of a Webpage” shall mean an image of the Webpage in any image format (e.g., JPEG, Bitmap, TIFF), in which the embedded links and/or streaming audio/video are inoperable.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

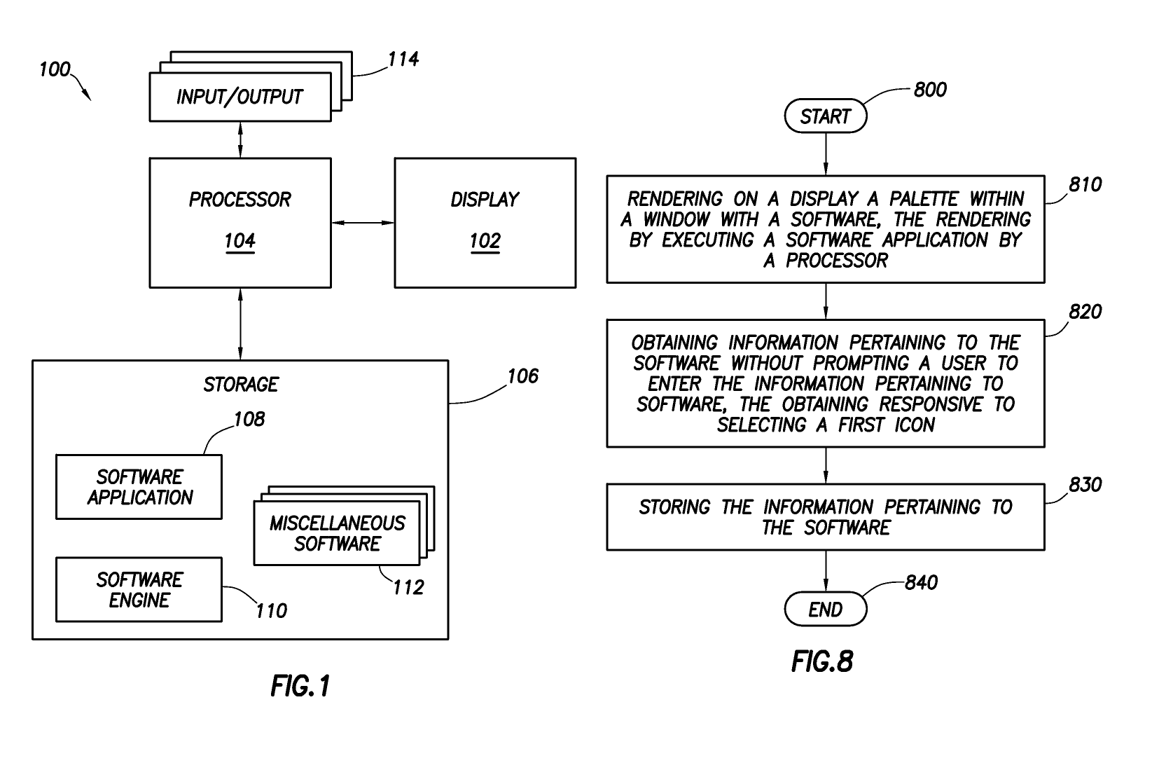

FIG. 1 shows a computer system 100 in accordance with at least some of the embodiments. In particular, the computer system 100 comprises a processor 104 (e.g., a microprocessor), and the processor 104 couples to a display 102, a storage or a memory 106 (e.g., random access memory (RAM), a hard drive), and input/output devices 114 (e.g., keyboard, mouse, microphone, optical sensors, printers, scanners, etc.). Programs executable by the processor 104 may be stored on the storage 106, and accessed when needed by the processor 104. Thus, the storage 106 is considered a computer-readable storage medium. The storage 106 stores a software application 108, a software engine 110 and miscellaneous software 112. In some embodiments, the computer system 100 may be any suitable type of system, such as desktop personal computer (PC) or a notebook computer.

When executed by the processor 104, the software application 108, in concert with the software engine 110 (or, in some embodiments, independent of the software engine 110), implements the various embodiments of the present specification. When the software application 108 is described herein as causing the processor 104 to perform an action, it should be understood that the software application 108 may be executed in tandem with the software engine 110. Further, the software application 108 performs at least some of the techniques described herein automatically (Le., without undue human intervention). The miscellaneous software 112 may comprise software such as web-browser software, word processing software, or spreadsheet software.

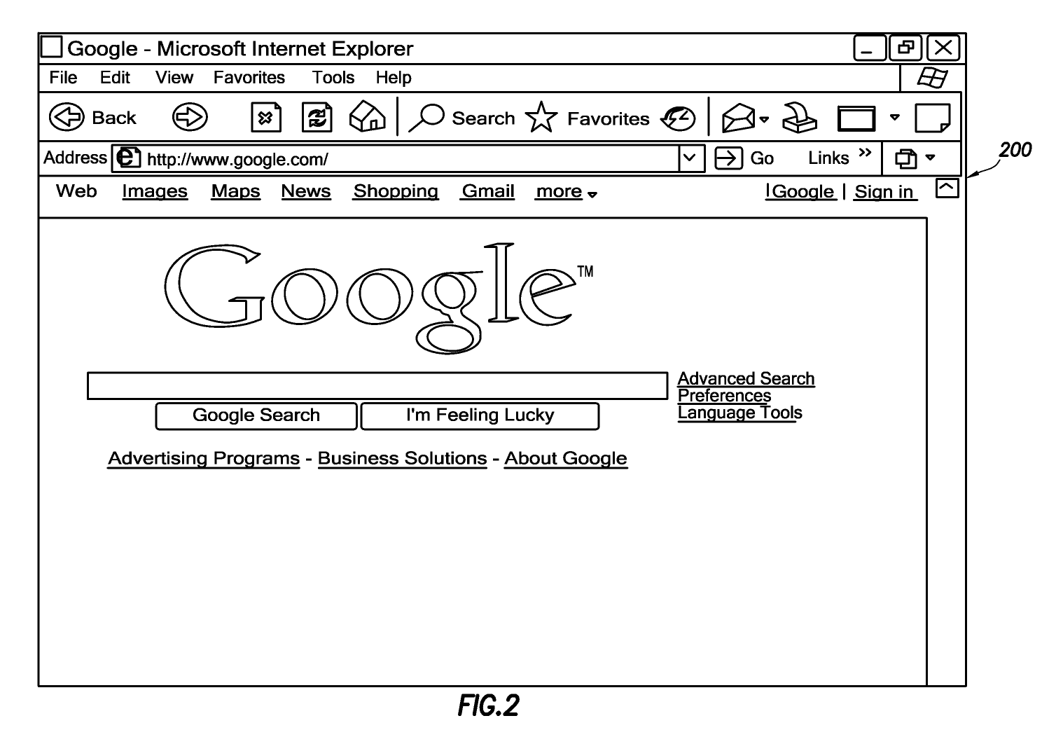

In at least some of the embodiments, the processor 104 accesses the storage 106 when needed to execute the miscellaneous software 112. Consider for the purpose of explanation, the miscellaneous software 112 is Web-browser software, then the processor 104 executes miscellaneous software 112 to render a window associated with the Web-browser on the display 102. For example, FIG. 2 shows a window 200 associated with a Web-browser (e.g., Internet Explorer®) rendered by the processor 104. Although, the exemplary embodiments are explained in the context of Web-browser, it should be noted that the software 112 may be any software 112 (e.g., word processing software, or spreadsheet software).

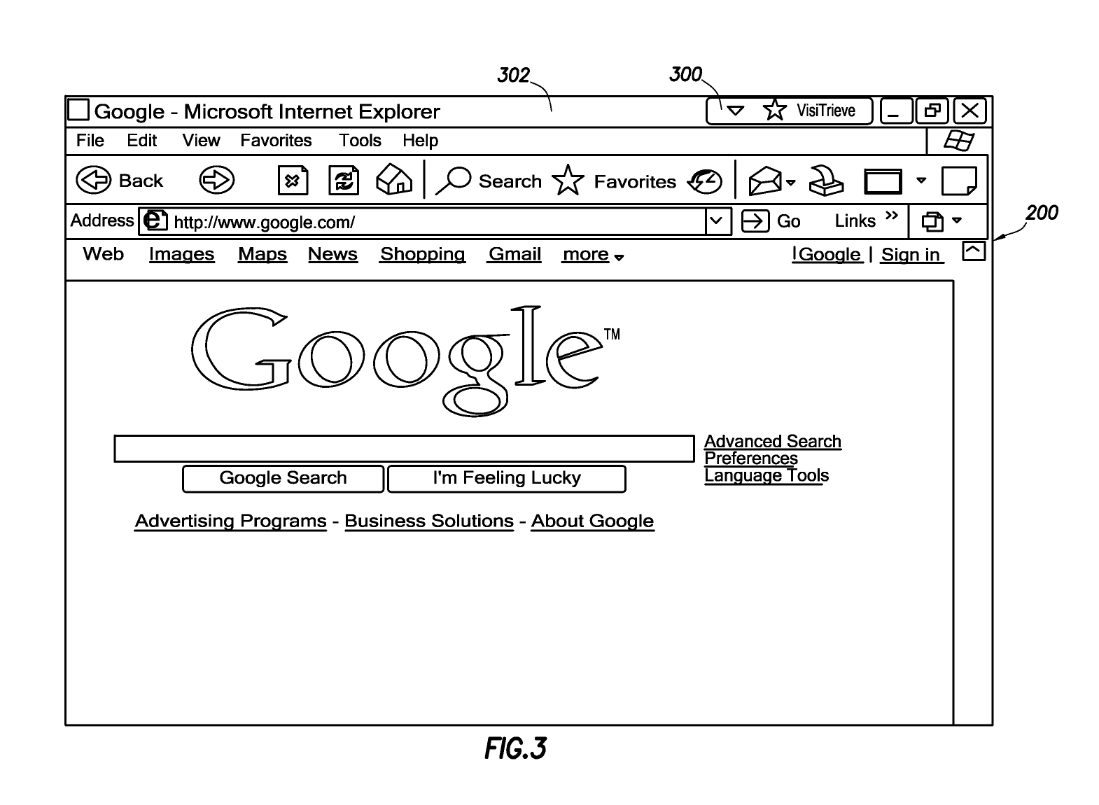

Continuing with the exemplary Web-browser of FIG. 2, when the processor 104 executes the software application 108, the software application 108 causes the processor 104 to render a palette at a predetermined location within the window 200 associated with Web-browser. FIG. 3 shows the window 200 associated with the Web-browser similar to the embodiments of FIG. 2, but having a palette 300 rendered on a title bar 302 of the window 200. The palette 300 may be rendered to be located on the title bar 302, or at any other location within the window 200. In some embodiments, the palette 300 is rendered outside and proximate to the window 200. When the palette 300 is rendered proximate to the window 200, the software application 108 causes the processor 104 to retain the location of the palette 300 proximate to the window 200 when the window is moved to a different location on the display 102. In other embodiments, a user may select and drag the palette 300 to any desired location within the window 200 or proximate to the window 200 using an input device (e.g., a mouse).

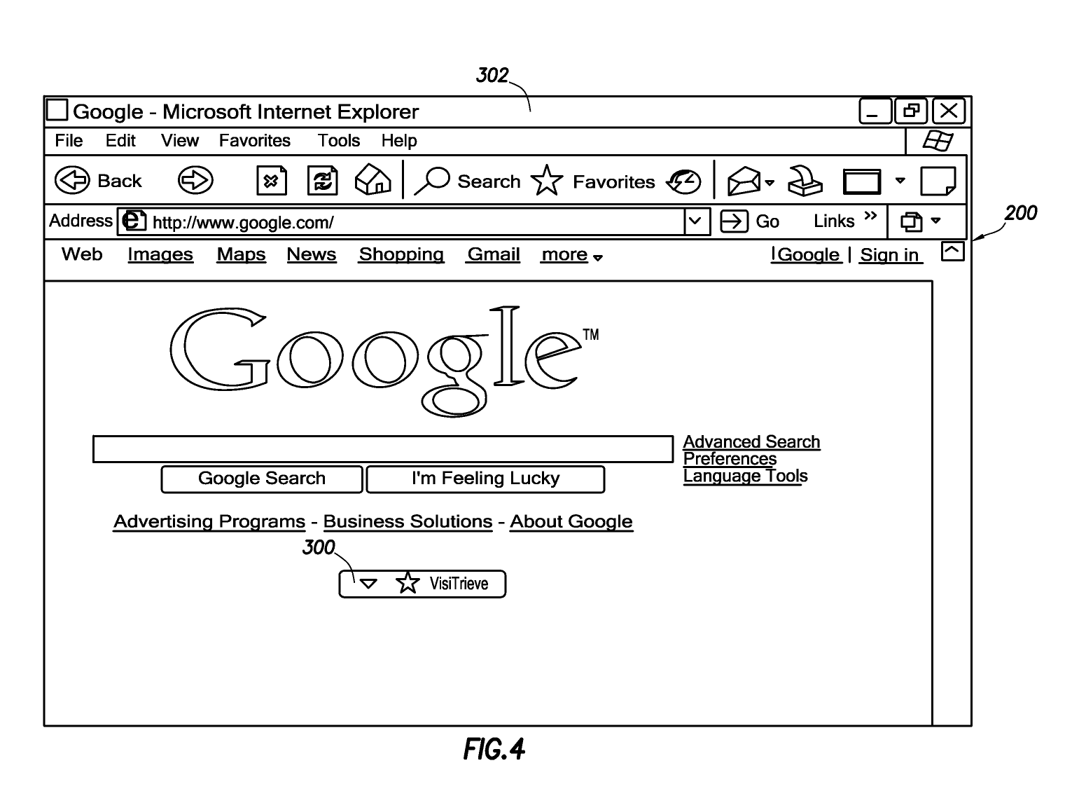

FIG. 4 shows a window 200 that is similar to the embodiments of FIG. 3, but the palette 300 has been dragged to a different location. The software application 108 is configured to store the location of the palette 300 within the window 200. Thus, if execution of the Web-browser associated with the window 200 is terminated and subsequently re-started, the palette 300 will automatically be rendered in the same location it was before execution of the Web-browser was terminated. In some embodiments, the palette 300 is rendered automatically when the window associated with a Web-browser is rendered by the processor 104.

The software application 108 is configured such that the adjustments made to the palette 300 are specific for the Web-browser associated with the window 200. For example, adjustments (e.g., relocation of the palette) made to the palette 300 within the window 200 of the illustrative Internet Explorer® Web-browser are independent of adjustments made to a palette within a window associated with another Web-browser, for example, a Firefox® Web-browser. Thus, if the illustrative Internet Explorer® window 200 is rendered and the palette 300 is re-located from the title bar 302 to a new location within the window 200, in the subsequently-rendered Internet Explorer® window 200 the palette 300 will be rendered at the new location. However, in the subsequently-rendered Firefox® window the palette will be rendered in the Firefox® browser's title bar (i.e., in a default location).

In some embodiments, the palette 300 is rendered when the Web-browser with which it is associated is the “active” or “top-most” software being executed by the processor 104. However, if the Web-browser is no longer the “active” or “top-most” software, the palette 300 disappears until the Web-browser is once again the active software executed by the processor 104. In at least some embodiments, the palette 300 is “application aware”. Stated otherwise, the palette 300 is associated with a window associated with a software (e.g., window 200 in FIG. 2), and automatically moves relative to the window as a user moves the window on the display. The palette 300 maintains its location within the window regardless of where the window is placed.

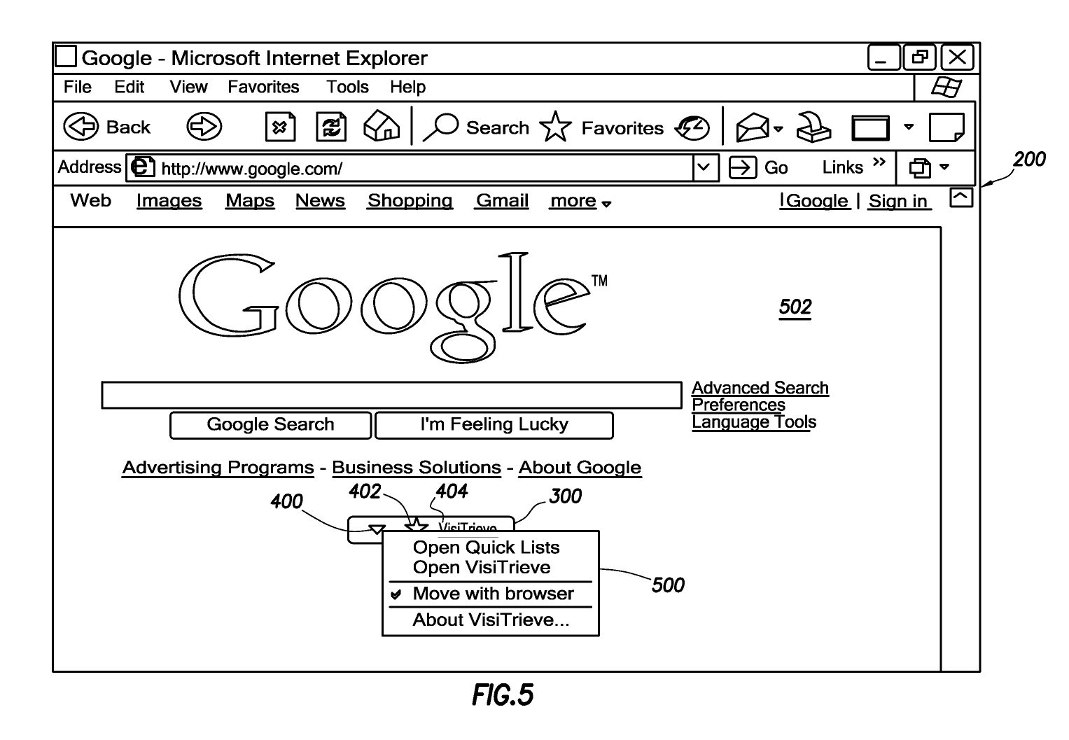

In the exemplary embodiment, the palette 300 is configured to enable a user to perform various functions related to the Web-browser associated with window 200. FIG. 5 shows the palette 300 within the window 200 similar to the embodiments of FIGS. 3 and 4. In particular, the palette 300 comprises an options icon 400, a tag icon 402 and a control console icon 404. When a user selects the options icon 400 using an input device (e.g., a mouse), the software application 208 causes the processor 104 to render a drop-down menu 500. Options in the drop-down menu 500 associated with palette 300 include an option to render a control console (as described below); an option for the palette 300 to move with the window 200 when the window 200 is moved on the display 102; and an option to obtain additional information about the software application 108. When the tag icon 402 is selected by the user using the input device, the software application 108 causes the processor 104 to tag a Webpage 502 that is being accessed by way of the Web-browser. In the particular embodiments, the Webpage 502 may be in any language (e.g., English, French, German, Italian, Portuguese and Spanish).

In particular, the palette 300 is configured to enable the user to obtain information pertaining to the Webpage 502 when the user selects the tag icon 402. In some embodiments, the information pertaining to the Webpage 502 is also stored in the storage 106. The information pertaining to the Webpage 502 may include information such as a Uniform Resource Locator (URL) associated with the Webpage 502, an image of the Webpage 502, source code of the Webpage 502, and keywords associated with the Webpage 502. In the particular embodiment, when the processor 104 obtains an image of the Webpage, the processor 104 is configured to capture a “picture” of the Webpage, and store the image of the Webpage in any image format (e.g., JPEG, Bitmap, TIFF). The embedded links and streaming audio/video within the Webpage are inoperable in the image of the Webpage. In some embodiments, the software application 108 causes the processor 104 to obtain keywords associated with Webpage 502 based a calculation of parameters, such as the frequency of the keywords in the webpage 502, formatting of the keywords in the Webpage 502, and position of the keywords within the webpage 502. The information pertaining to the Webpage 502 is obtained without prompting the user to enter the information pertaining to the Webpage 502. For example, unlike the bookmarking feature associated with related Web-browser software which requires the user to input information pertaining to the Webpage 502, the palette 300 is configured to automatically obtain information pertaining to the Webpage 502 without user input.

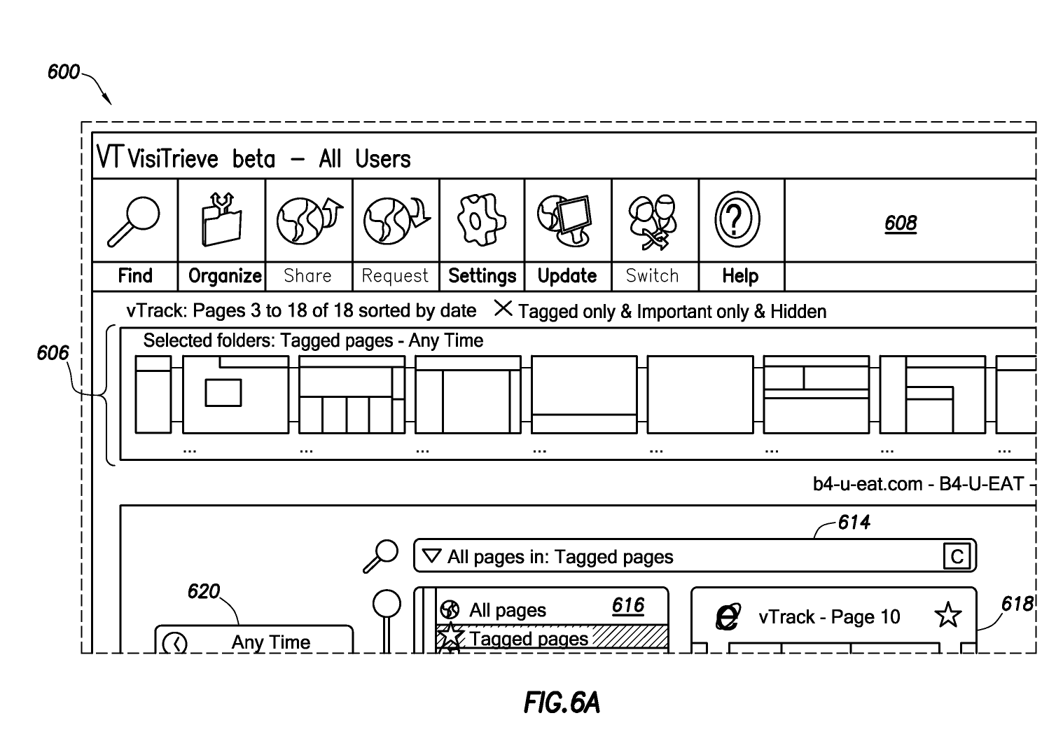

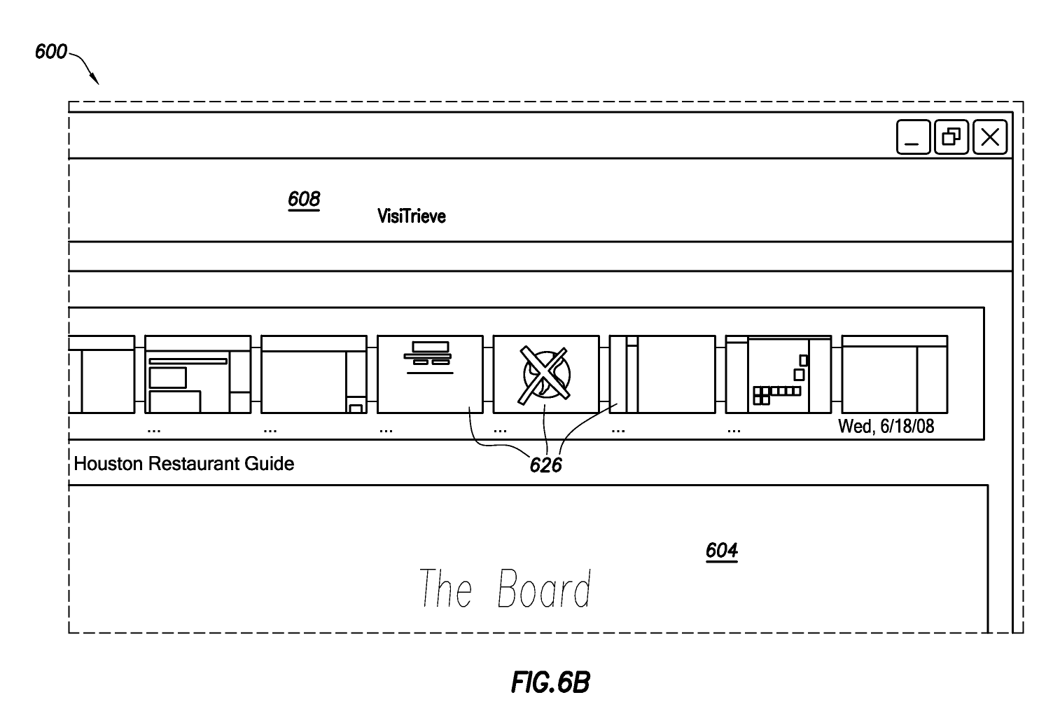

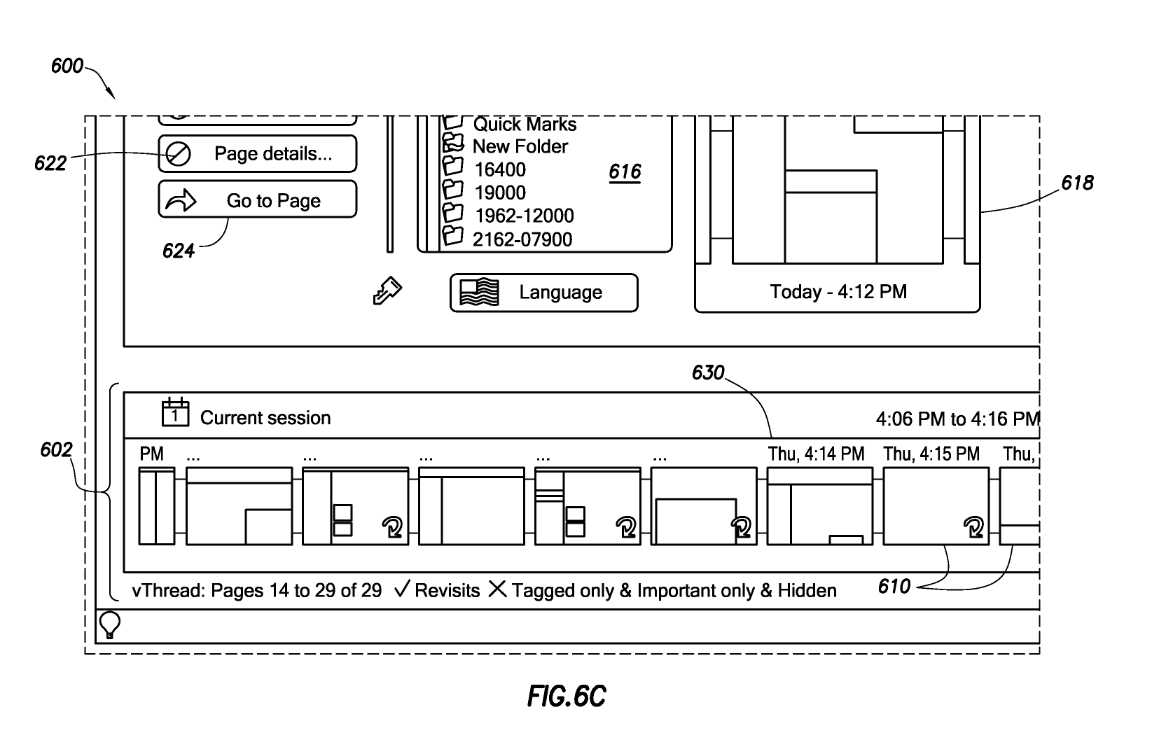

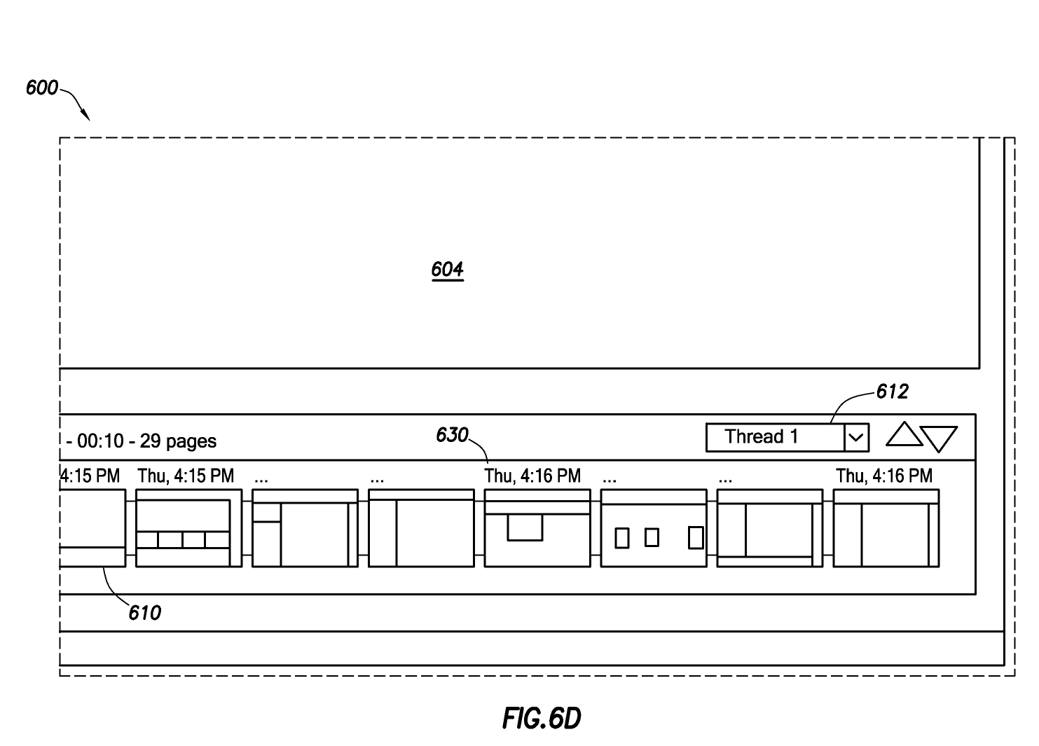

When the control console icon 404 is selected by the user using the input device, the software application 108 causes the processor 104 to render a control console on the display 102. FIGS. 6A-6D shows an exemplary control console 600 rendered by the processor 104 in accordance with at least some of the embodiments. The control console 600 comprises a Graphical User Interface (GUI) that enables the user to manage information pertaining to Webpages tagged by the user by selecting the tag icon 402, review previously accessed Webpages, and search the information pertaining to the Webpages stored on the storage 106. In the exemplary embodiment, the control console 600 comprises multiple sections 602, 604, 606 and 608. In the exemplary embodiment, section 602 comprises plurality of images 610 of Webpages that have been accessed by way of the Web-browser. At least some of the images 610 in section 602 are labeled with a time 630 at which the corresponding Webpage was accessed. In some embodiments, the section 602 comprises additional information associated with the images 610, including dates when the corresponding Webpages were accessed, session numbers, the total number of images 610, whether the corresponding to Webpages were private or secure, whether corresponding Webpages were re-accessed. Section 602 also comprises a thread drop-down menu 612 from which the user may select a thread to display images associated with the thread in section 602.

A thread comprises a series of Webpages accessed by way of a Web-browser that are related. For example, a thread may comprise a series of Webpages that were accessed during a period of time based on the embedded links in the Webpages. Consider for purpose of explanation, a window associated with a Web-browser is rendered by the processor 104 and a first Webpage is accessed by Web-browser. Thereafter, the user selects at least one of the embedded links in the first Webpage to access a second Webpage by the Web-browser, and subsequently selects another embedded link in either the first Webpage or the second Webpage to access a third Webpage by the Web-browser. In such an illustrative situation, a thread (e.g., thread 1) and comprising the first, second and third Webpages and the period of time during which the first, second and third Webpages were accessed is created by the software application 108. An image (i.e., similar to image 610) corresponding to each of the first, second and third Webpages of the thread are stored in the storage 106, and the images may be displayed in section 602 when the thread (i.e., thread 1) is selected from the thread drop-down menu 612. FIGS. 6C-6D shows in section 602 images 610 of Webpages corresponding to an exemplary thread 612 “thread 1” which comprises a series of Webpages accessed on Thursday between 4:06 PM and 4:16 PM.

In other embodiments, during a particular period of time, a first Webpage is accessed, and the user selects at least one of the embedded links in the first Webpage to access a second Webpage. Thereafter, a third Webpage is accessed without selecting any of the embedded links in the first or the second Webpage. In such an illustrative situation, a first thread comprising the first and the second Webpages is created by the software application 108, and a second thread comprising the third Webpage is created by the software application 108. Stated otherwise, a thread comprises the series of Webpages that were accessed by selecting one of the embedded links in the Webpages. A new thread is created when a Webpage is accessed that did not require selecting one of embedded links in the previously accessed Webpages. In some embodiments, the exemplary threads are automatically delineated based on the embedded links selected within the webpages.

A thread is not limited to Webpages accessed by way of a particular Web-browser (e.g., Internet Explorer® and Firefox®), and instead a thread may comprise Webpages accessed by way any of Web-browser at disparate times. For example, Webpages accessed by way Internet Explorer® are delineated by the software application 108 as comprising in the same thread as Webpages accessed by way Firefox®. The Webpages are delineated when at least some of the information pertaining to the Webpages is similar (e.g., common keywords, phrases). Thus, if the information pertaining to the Webpages accessed by way Internet Explorer®, and the information pertaining to the Webpages accessed by way Firefox® comprise at least some similar information, a thread is created comprising the Webpages accessed by both Web-browsers. In some embodiments, a thread comprises Webpages accessed within a single day. In other embodiments, a thread comprises Webpages accessed within any time period (hours, day, days, weeks, etc.).

Still referring to FIGS. 6A-6D, section 618 displays a larger image of an image 610 or 626 selected from in either section 602 or 606. In some embodiments, section 618 displays a large image of the last image in 602 or 606 over which the user hovers a cursor associated with an input device (e.g., a mouse). Section 604 of the illustrative control console 600 enables a user to search the information pertaining to Webpages obtained by the software application 108 and stored in the storage 106. In particular, the user is enabled to search the information pertaining to the Webpages by inputting specific keywords or phrases in a search window 614. For example, the user may input the term “CNN” into search window 614 and in response to the input the processor 104 searches the information pertaining to the Webpages and the images of the Webpages stored on the storage 106. Section 616 of the control console 600 displays search results. In particular, section 616 displays some or all of the information pertaining to Webpages stored on the storage 106. When the user inputs search keywords or phrases in the search window 614, the processor 104 groups the Webpages whose information comprises the keywords or phrases. For example, all Webpages whose information comprises the keyword “CNN” are grouped together and displayed as a single group or folder in the section 616. In some embodiments, the user also may be able to sort based on tagged pages, or quick marked folders as displayed in section 616.

In some embodiments, section 606 displays a plurality of images 626 of Webpages that correspond to a highlighted item in the section 616. For example, FIG. 6 shows that “tagged pages” is highlighted in section 616, and accordingly, the images 626 displayed in section 606 correspond to Webpages that are grouped as “tagged pages”. Stated otherwise, the section 606 displays images 626 of Webpages grouped based on search keywords or phrases, and the group displayed in the section 616.

FIGS. 6A-6D illustrates in section 604 icons 620, 622 and 624. Icon 620 when selected by a user enables the user to search the information pertaining to the Webpages stored on the storage 106 based a time criteria. Icon 622, when selected by the user causes the processor 104 to display information pertaining to the Webpage corresponding with the image displayed in section 618. Icon 624, when selected by the user causes the Webpage corresponding with the image displayed in section 618 to be accessed by way of a Web-browser. Stated otherwise, when the icon 624 is selected, the software application 108 causes the processor 104 to access via the Internet the Webpage corresponding with the image displayed in section 618. Moreover, embedded links and/or streaming audio/video within the Webpage accessed in response to selection of icon 624 are operable. In some embodiments, in response to the selection of icon 624 the Webpage is accessed by the Web-browser using a cached copy of the Webpage. When the section 618 is selected, the processor 104 in response to the selection of the section 618 enlarges the image of the Webpage displayed in the section 618. The enlarged image of the Webpage is based on the image of the Webpage obtained by the processor 104 and stored in the storage 106.

FIGS. 6A-6D also illustrates a section 608 that comprises icons for various options associated with the control console 600. In particular, section 608 comprises icons that enable a user to find, organize and share the information pertaining to the Webpages displayed or available through the control console 600. Section 608 also comprises icons to enable users to request information pertaining to Webpages from other computer systems executing the software application 108 that are communicably coupled to the computer system 100. Moreover, section 608 comprises icons to adjust settings of the control console 600, update the software application 108, switch users, provide help regarding the control console 600.

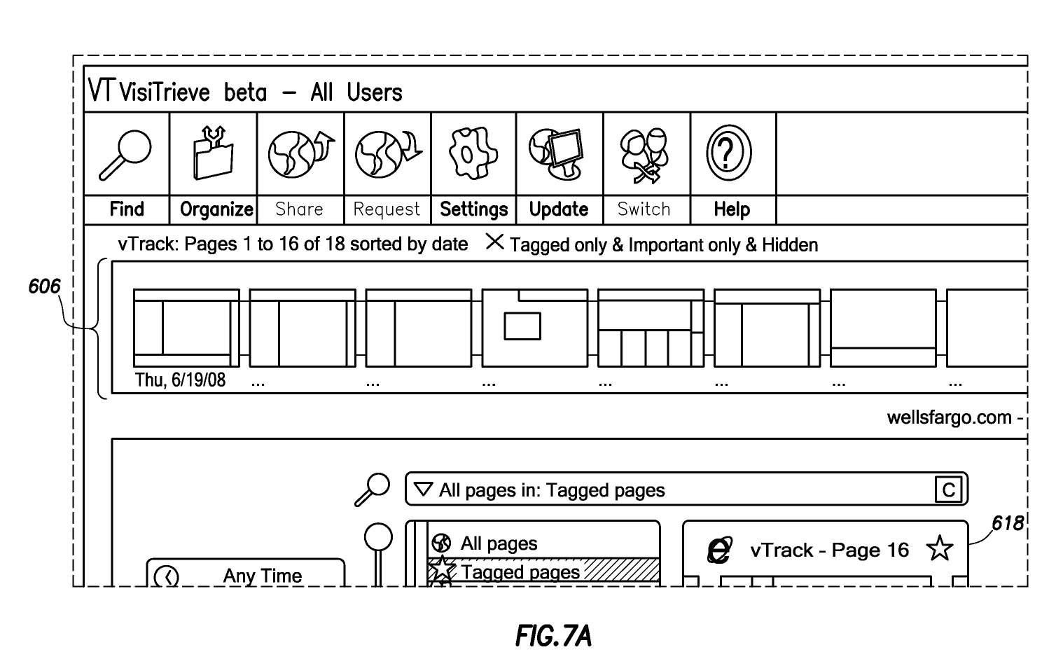

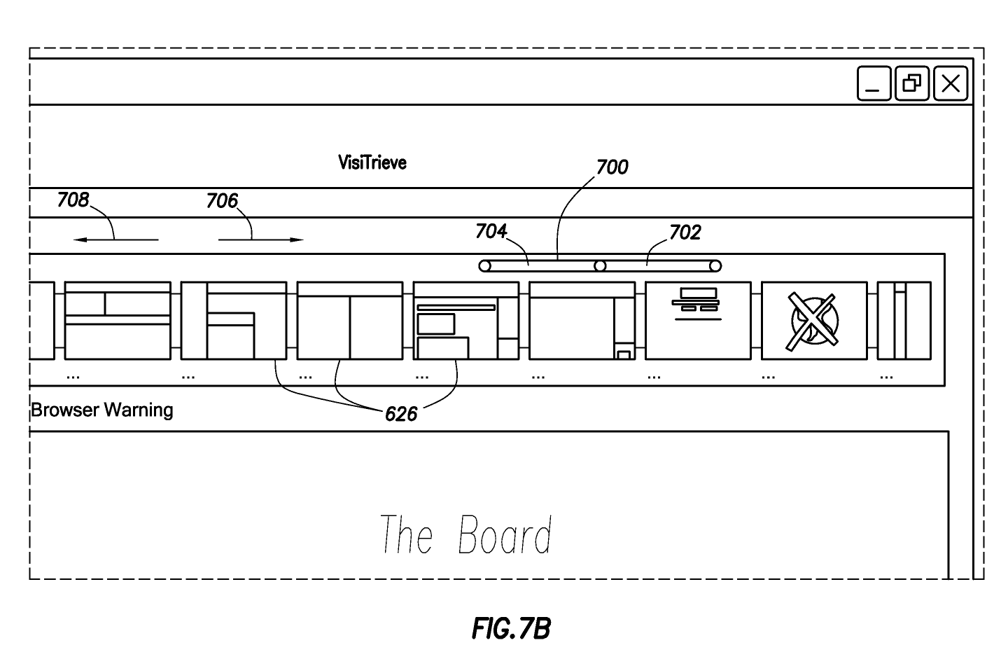

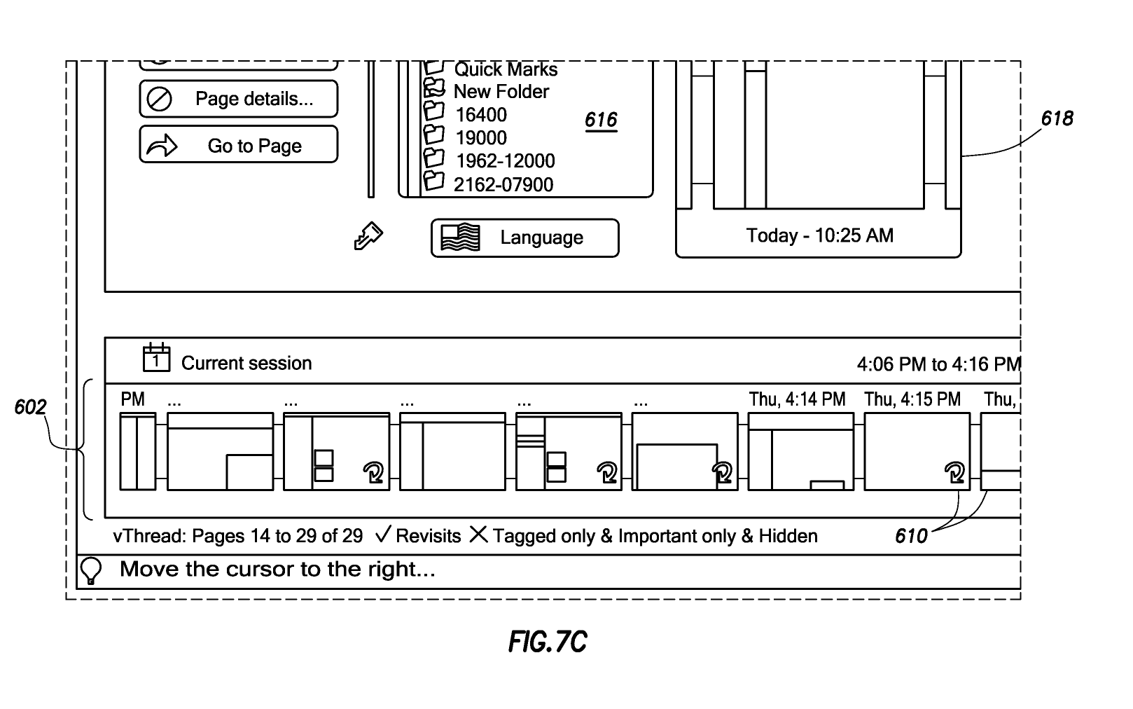

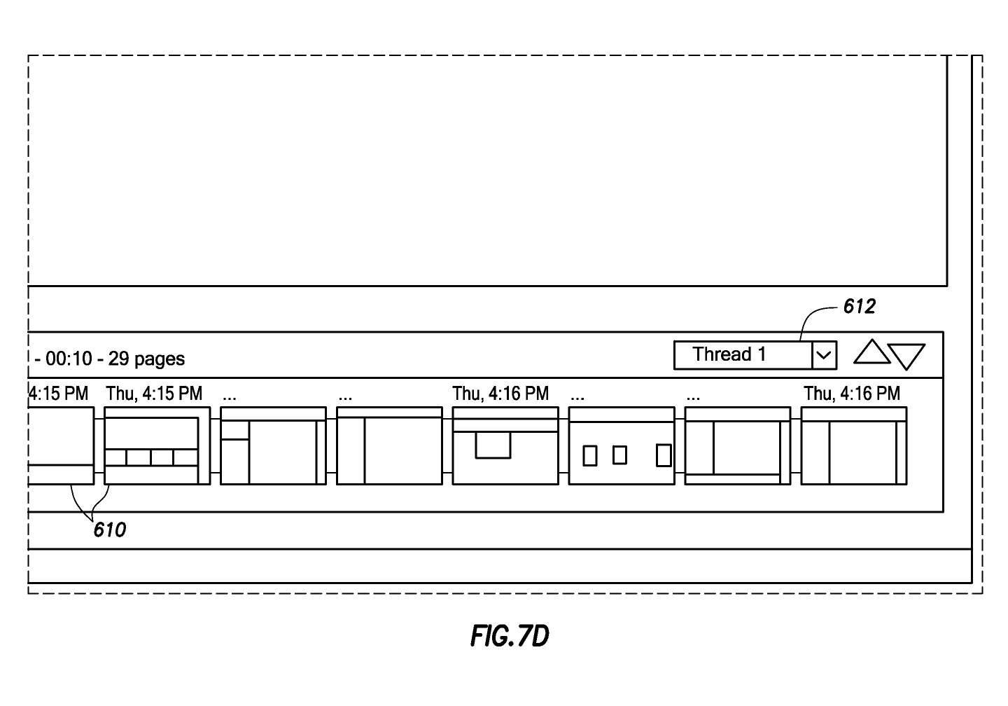

In some embodiments, all the images 626 associated with the highlighted item in section 616 and all the images 610 associated with the thread may not be displayed at the same time in section 606 and section 602, respectively. Thus, in a particular embodiment, the processor 104 is configured to render a scroll bar to quickly and easily scroll through the images 610 and 626. FIG. 7A-7D illustrates a scroll bar 700 in accordance with at least some of the embodiments. In particular, FIG. 7B illustrates the scroll bar 700 located in section 606 of the control console 600. In some embodiments, the scroll bar 700 may be rendered where the cursor associated with an input device (e.g., a mouse) is located in the sections 602 or 606. In alternative embodiment, the scroll bar 700 may be rendered at predefined location within the sections 602 or 606. When the cursor associated with input device is hovered over the right-side half 702 of the scroll bar 700, the processor 104 is configured to scroll the images 610 or 626 to the right as indicated by arrow 706. Similarly, when the cursor associated with input device is hovered over the left-side half 704 of the scroll bar 700, the processor 104 is configured to scroll the images 610 or 626 to the left as indicated by arrow 708.

The scroll bar 700 preferably is variable speed, meaning that the speed at which the illustrative images 626 are scrolled is adjustable as desired. The speed may be adjusted, for example, based on the portion of the scroll bar 700 over which the cursor hovered. The speed at which the illustrative images 626 are scrolled through increases as the cursor is hovered further away from the center of the scroll bar 700 and the speed at which the illustrative images 626 are scrolled through decreases as the cursor is hovered closer to the center of the scroll bar 700. For example, as the cursor is hovered further away from the center and to the right, the speed at which the images 626 are scrolled in the direction indicated by arrow 706 increases. Similarly, as the cursor is hovered further away from the center and to the left, the speed at which the images 626 are scrolled in the direction indicated by arrow 708 increases. In at least some embodiments, the scroll bar 700 does not require selecting by the input device (i.e., a mouse) to be operated.

FIG. 8 illustrates a method in accordance with at least some of the embodiments. In particular, the method begins (Block 800), and a palette is render on a display within a window of a software (Block 810). In some embodiments, the palette is rendered by executing a software application by a processor. Next, information pertaining to the software is obtained in response to selecting a first icon (Block 820). The information pertaining to the software is obtained without prompting the user to enter the information pertaining to the software. Thereafter, the information pertaining to the software is stored (Block 830), and the method ends (Block 840).

From the description provided herein, those skilled in the art are readily able to combine software created as described with appropriate computer hardware to create a special purpose computer system and/or special purpose computer sub-components in accordance with the various embodiments, to create a special purpose computer system and/or computer sub-components for carrying out the methods of the various embodiments and/or to create a computer-readable media that stores a software program to implement the method aspects of the various embodiments.

While the preferred embodiments of the present invention have been shown and described, modifications thereof can be made by one skilled in the art without departing from the spirit and teachings of the invention. For example, while the various embodiments are related to a Windows® operating systems utilizing Internet Explorer®, the palette 300 are equally applicable and functional with any operating system (e.g., Macintosh OSX, Unix, Linux). In particular, the software application 108 described herein is cross-browser (i.e., compatible with any browser), cross-platform (i.e., compatible with PC, Mac, UNIX and Linux), cross-lingual (i.e., operable in languages, such as English, French, German, Italian, Portuguese and Spanish), cross-format, cross-machine (i.e., can be executed on separate computer systems integrated into a central location); cross-application (i.e., palette may be rendered within software); and most importantly can integrate the use and data across all of these. The scope of protection is not limited by the description set out above. Each and every claim is incorporated into the specification as an embodiment of the present invention.

We claim:

1. A system, comprising:
a processor;
a memory coupled to the processor;
the memory stores a program that, when executed by the processor, causes the processor to:
render on a display a palette at a predetermined location within a window of a software;
obtain, at the behest of a user, information pertaining to the software without prompts for user to enter the information pertaining to the software, and
store the information pertaining to the software on a storage device.

2. The system as defined in claim 1 wherein when the processor renders the palette, the program further causes the processor to:
render an icon configured to display options associated with the palette,
render an icon configured to tag; and
render an icon configured to cause the processor to render a control console.

3. The system as defined in claim 1 wherein the software is a Web-browser, and when the processor renders the palette, the program further causes the processor to tag, at the behest of a user, a Webpage accessed by way of the Web-browser, and obtain information pertaining to the Webpage.

4. The system as defined in clam 3 wherein when the processor obtains the information pertaining to the Webpage, the program further causes the processor to obtain at least one selected from the group consisting of: a Uniform Resource Locator (URL) associated with Webpage; an image of the Webpage; source code of the Webpage; and a keyword associated with the Webpage.

5. The system as defined in claim 3 wherein when the processor renders the palette, the program further causes the processor to create a thread of related Webpages tagged by the user.

6. The system as defined in claim 1 wherein when the processor renders the palette, the program further causes the processor to render a control console that is configured to display at least some of the information pertaining to the software.

7. The system as defined in claim 6 wherein when the processor renders the control console, the program further causes the processor to
render a scroll bar at a location of a cursor within the control console; and
scroll, based on location of the cursor hovered over the scroll bar, at variable speed through the least some of the information pertaining to the software displayed in control console.

8. The system as defined in claim 7 wherein when the processor renders the scroll bar, the program further causes the processor to
scroll the information pertaining to the software to the right when the cursor hovers over a right side of the scroll bar; and
scroll the information pertaining to the software to the left, when the cursor hovers over a left side of the scroll bar.

9. The systems as defined in claim 6 wherein the processor renders the control console, the program further causes the processor to render a search window and search the information pertaining to software stored on the storage device in response to the user input.

10. A method comprising:
rendering on a display a palette within a window of a software, the rendering by executing a software application by a processor;
obtaining information pertaining to the software without prompting a user to enter the information pertaining to software, the obtaining responsive to selecting a first icon; and
storing the information pertaining to the software.

11. The method as defined in claim 10 wherein rendering further comprising rendering the palette with an icon for displaying options associated with the palette, an icon for tagging and an icon for rendering a control console.

12. The method as defined in claim 10 further comprising:
rendering, by the processor, a control console to display the at least some of the information pertaining to the software, and rendering the control console responsive to selecting a second icon on the palette;
rendering, by the processor, a scroll bar at a location of a cursor within the control console; and
scrolling at variable speed through the at least some of the information pertaining to software responsive to hovering the cursor over the scroll bar.

13. The method as defined in claim 12 further comprising:
searching the stored information pertaining to the software, the searching based on keywords; and
displaying search results within the control console.

14. A computer-readable storage medium storing a program that, when executed by a processor, causes the processor to:
render on a display a palette within a window associated with a software;
obtain information pertaining to the software without prompting a user to enter the information pertaining to the software; and
store the information pertaining to the software on a storage device.

15. The computer-readable storage medium of claim 14 wherein when the processor renders, the program causes the processor to render within the palette an icon that, when selected, causes the processor to displays options associated with the palette, an icon that, when selected, causes the processor to tag and an icon that, when selected, cause the processing to render a control console.

16. The computer-readable storage medium of claim 14 wherein when the software is a Web-Browser, the program causes the processor to obtain information pertaining to the Webpage accessed by way of the Web-Browser.

17. The computer-readable storage medium of claim 16 wherein when the processor obtains information pertaining to the Webpage, the program causes the processor to obtain at least one selected from the group consisting of: a Uniform Resource Locator (URL) associated with Webpage; an image of the Webpage; source code of the Webpage; and a keyword associated with the Webpage.

18. The computer-readable storage medium of claim 16 wherein the program causes the processor to create a thread of Webpages that are related.

19. The computer-readable storage medium of claim 14 wherein the program causes the processor to render a control console to display at least some of the information pertaining to the software.

20. The computer-readable storage medium of claim 19 wherein the program further causes the processor to:
render a scroll bar at a location of a cursor within the control console; and
scroll at variable speed through the least some of the information pertaining to the software displayed in control console.
